(19) United States
(12) Patent Application Publication
(10) Pub. No.: US 2012/0094164 A1
(43) Pub. Date: Apr. 19, 2012

(54) MODULAR SYSTEM FOR AN ACCUMULATOR

(75) Inventor: Ralph Wuensche, Graz (AT)

(73) Assignee: MAGNA E-CAR SYSTEMS GMBH & CO OG, Graz (AT)

(21) Appl. No.: 13/269,740

(22) Filed: Oct. 10, 2011

Related U.S. Application Data
(60) Provisional application No. 61/392,731, filed on Oct. 13, 2010.

(30) Foreign Application Priority Data
Jan. 28, 2011 (DE) 102011009753.8

(51) Int. Cl. H01M 2/10

(52) U.S. Cl. 429/100; 29/428

(57) ABSTRACT

A modular system for an essentially cuboid-shaped accumulator is provided, comprising at least one voltage generating cell and at least two loose housing elements. The housing elements each comprise maximally three side parts and together comprise at least four side parts, wherein each side part is provided for limiting one respective side of the cuboid-shaped accumulator. The modular system further comprises at least one additional alternative housing element which can be directly used instead of a housing element fulfilling a first function and which fulfills a second function different from the first function. Furthermore, an accumulator is provided which is built up of the components of said modular system.

### BACKGROUND OF THE INVENTION

1. Technical Field

The invention relates to a modular system for an essentially cuboid-shaped accumulator comprising at least one voltage generating cell and at least two loose housing elements each comprising maximally three side parts and together comprising at least four side parts, wherein each side part is provided for limiting one respective side of the cuboid-shaped accumulator. Furthermore, the invention relates to an accumulator built up of the components of the modular system.

2. Prior Art

Methods for manufacturing accumulators as well as modular systems in which an accumulator is built up of a variable number of cells are already known from the prior art.

DE 602 07 158 T2, for example, discloses an accumulator in which the cells are installed in a shell-shaped or box-shaped housing element. Said shell-shaped or box-shaped housing element is closed by a cover having plugs engaging in holes of the housing element. Furthermore, various arrangements of cells are proposed. For these cases, however, a different housing is necessary.

Further, DE 100 27 385 A discloses a structure for preventing a mistake during assembly of an accumulator comprising a first unit, a second unit as well as a plurality of attachment devices which are spaced at equal intervals and with which the first and the second units are assembled. Furthermore, the structure comprises two types of positioning frames, a large one and a small one, which are provided variably on one of the first and second units, and a protrusion device provided on the other one of the first and second units. Any discrepancy in interval is prevented during assembly of a battery connection plate with a battery construction.

Finally, DE 31 03 534 A1 discloses a battery housing manufactured as an integral injection-molded piece for receiving galvanic elements which can be stacked in the shape of a column. Therein the battery housing is formed by two half-shells which can be folded together and are interconnected through a flexible film hinge. A contact spring led across the external wall of a half-shell enables series connection of two columns arranged in parallel, while further contact elements connect the first and the last cells in the overall assembly with the positive pole and the negative pole, respectively, at the end sides of the battery housing. When the half-shells are folded together, they are shut by means of a self-locking snap lock.

In the known solutions it is disadvantageous that the accumulators according to the prior art consist of a plurality of special components which cannot be exchanged among one another. This renders manufacturing of different types of accumulators more difficult.

### SUMMARY OF THE INVENTION

Therefore the object underlying the present invention is to provide an improved modular system for an accumulator, an improved accumulator as well as an improved manufacturing method for an accumulator. In particular, the invention is to create a simple and cost-effective possibility of manufacturing a plurality of different types of accumulators.

The object of the invention is achieved by a modular system of the above-mentioned type, wherein at least one additional alternative housing element can be directly used instead of a housing element fulfilling a first function and fulfills a second function different from the first function.

The object of the invention is further achieved by an accumulator built up of the components of a modular system according to the invention.

By the invention the disadvantages of the above-mentioned prior art are overcome, because the modular system makes it possible to manufacture a plurality of different types of accumulators using a comparably small number of components. Stock keeping of the components as well as assembly per se is facilitated thereby, which is why an accumulator according to the invention can be manufactured in a cost-effective manner. In particular, the housing elements are made of plastic material, whereby a plurality of different accumulators can be manufactured with a comparably small technical effort.

The terms “housing element” and “alternative housing element” designate two housing elements which can be used alternatively at the same position of the housing. For this reason, the terms “housing element” and “alternative housing element” can also be used interchangeably.

The term “can be directly used” means within the framework of the invention that for exchanging the housing element by an alternative housing element no further retrofitting work at the accumulator is necessary. This is realized in an advantageous variant of the invention by the fact that the connection elements, which are necessary for connecting the housing elements to one another, on the housing element and on the alternative housing element are identical. Of course, the connection elements may also be designed to be variable; however, the possibility of directly inserting the alternative housing element should be maintained.

Advantageous embodiments and further developments of the invention can be gathered from the dependent claims as well as from the description in combination with the figures.

It is especially advantageous if by the housing element and the at least one alternative housing element at least two functions or embodiments of the following group are realized: consisting of a massive material, consisting of a material having closed cavities or consisting of a material having an integrated channel which is prepared for being flown through by a fluid. In this way, accumulators can be built up, wherein the housing thereof consists of a massive material or of foamed material or wherein the housing comprises a channel which can be connected to a climate control circuit and in such a way is flown through by a fluid which is able to heat or cool the accumulator depending on the respective requirement.

Further, it is especially advantageous if
the housing element and the at least one alternative housing element each comprise a cell connection unit for electrical connection of at least two voltage generating cells and
that by the housing element and the at least one alternative housing element at least two functions or embodiments of the following group are realized: forming a series connection of the cells, forming a parallel connection of the cells, forming a first combined series and parallel connection of the cells or forming a second combined series and parallel connection of the cells which is different from the first combined series and parallel connection.
   As a result it is very easy to manufacture accumulators having different voltages and different capacities.

Additionally, it is especially advantageous if by the housing element and the at least one alternative housing element at least two functions or embodiments of the following group are realized: comprising mounting means for attaching a side element in parallel to a base surface, comprising mounting means for attaching a side element in perpendicular to a base surface, comprising mounting means for attaching a side element angularly to a base surface or provided for any desired arrangement relatively to a base surface. With the aid of the mentioned mounting means the accumulator can be attached in different ways to a base surface, for example, on a surface in a motor vehicle which is prepared for installation of the accumulator according to the invention. Of course, it is also conceivable that a housing element does not comprise any mounting means and can thus be arranged in any way with respect to a base surface.

It is also advantageous if a housing element comprises a cell monitoring unit for monitoring at least two voltage generating cells. In this way, for example, the voltages of the cells can be determined.

It is favorable if a housing element is formed of exactly one side part. In this way the housing elements can be used in an especially flexible manner; additionally, the number of the elements of the modular system is reduced thereby. In an especially advantageous variant all housing elements or side parts, respectively, have an identical structure.

It is also favorable if a housing element is formed by at least two side parts connected through a hinge or by at least two side parts connected angularly and fixedly with respect to one another. In this way, the assembly operation can be facilitated, i.e. the number of assembly steps can be reduced because only comparably few components are to be assembled for the manufacture of an accumulator.

It is especially advantageous if at least two housing elements can be connected to one another through snap hooks (also known by the term “locking hooks”). In this way the accumulator can be assembled in an especially simple manner, in particular also without any tools.

It is advantageous if the housing elements are prepared for limiting the accumulator at its assembled state at exactly four sides. Due to its open design, the accumulator, on the one hand, is especially lightweight, on the other hand, only comparably few components are required for manufacturing an accumulator.

It is favorable if at least two housing elements are identical. In this way the number of the components in a modular system can be further reduced and the assembly of the accumulator can be further facilitated. For example, housing elements laterally limiting the accumulator can have an identical structure.

It is especially advantageous if a housing element is point symmetric. Due to this fact the housing element in question can be installed in two different positions, namely positions rotated by 180°. Therefore assembly of an accumulator can be even further facilitated.

It is favorable if at least two of the components of the accumulator according to the invention are glued together. For example, several voltage generating cells and/or several housing elements can be glued together. As a result the accumulator is per se very stable and is able to sustain higher loads. In case a heat conductible adhesive is used, even the heat conductibility between the cells or between the housing and the cells can be improved.

Especially advantageous in this connection is a method of manufacturing an accumulator, comprising the steps:

a) applying adhesive to at least one of the components of the accumulator;
b) assembling said components;
c) fixing the components by actuating the snap hooks arranged on the housing elements; and
d) storing the accumulator in a free-standing manner until the adhesive has hardened.

In this way the accumulator, on the one hand, can be manufactured without any tools, on the other hand, a durable connection of the parts concerned is achieved by gluing them together. The term “storing . . . in a free-standing manner” means within the framework of the invention that hardening of the adhesive in step d) of the method according to the invention is done without a clamping device. Thus, a clamping device for pressing the parts to be glued to one another together is not necessary for hardening of the adhesive. Therefore the accumulator can, for example, directly after its assembly be packed or even be shipped, because the adhesive is able to harden in the packaging or during transport. Of course, still further production steps may be performed until the accumulator eventually hardens prior to its shipment in an intermediate storage. Anyway, manufacturing an accumulator according to the mentioned method is especially simple and fast.

The above configurations and further developments of the invention can be combined in any desired way.

### BRIEF DESCRIPTION OF THE DRAWINGS

Hereinafter the present invention will be explained in greater detail by way of exemplary embodiments shown in the schematic figures of the drawing, wherein

FIG. 1 shows a first embodiment of an accumulator according to the invention;

FIG. 2 shows the steps during manufacture of the accumulator shown in FIG. 1;

FIG. 3 shows a cross section of the accumulator shown in FIG. 1;

FIG. 4 shows a detailed view of a cover element of the accumulator of FIG. 1;

FIG. 5 shows the accumulator of FIG. 1 as seen angularly from below;

FIG. 6 shows a second embodiment of an accumulator according to the invention, which is prepared for adjusting the temperature by a fluid; and

FIG. 7 shows another embodiment of the accumulator according to the invention, wherein a cell monitoring unit is mounted on the cover element.

### DETAILED DESCRIPTION

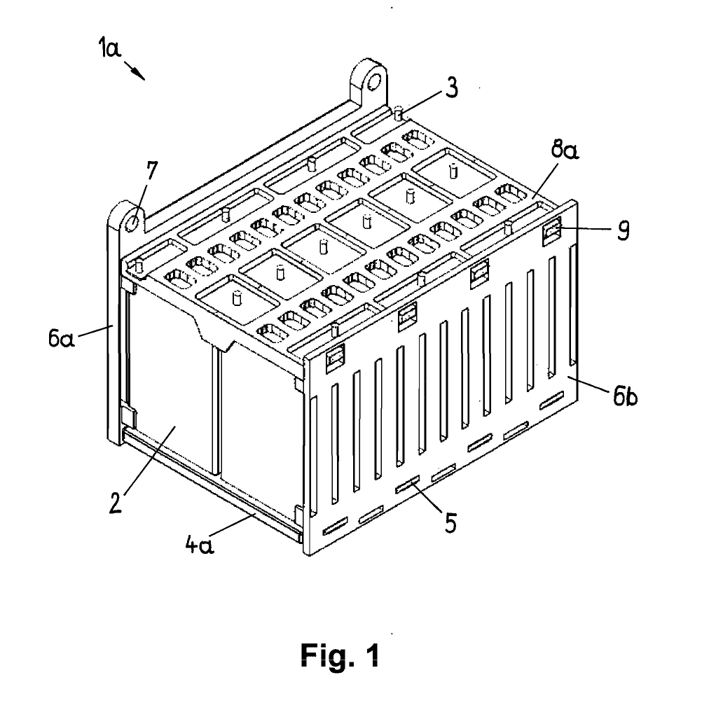

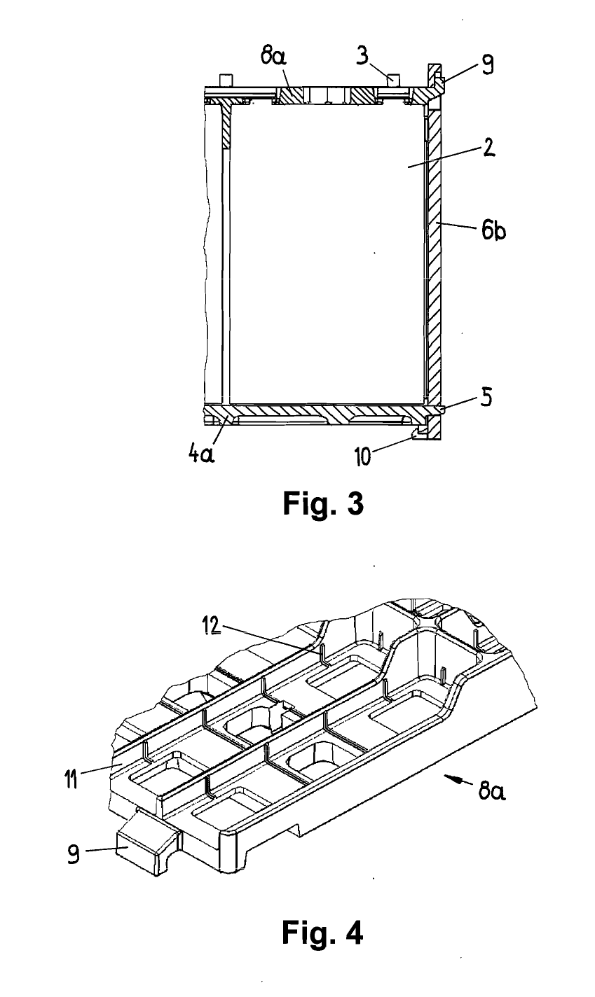

FIG. 1 shows a first example of an accumulator 1a according to the invention. The accumulator 1a is essentially cuboid-shaped and comprises several voltage generating cells 2 with cell connectors 3. A first housing element 4a, in this case a bottom element, limits the accumulator 1a at a first side. The bottom element 4a comprises several projections 5 engaging in recesses of a second housing element 6a and a third housing element 6b. In this example, the housing elements 6a and 6b are formed as side elements. The side element 6a additionally comprises attachment means for attaching the accumulator 1a at a base surface in the form of an attachment tongue V. At the top side the accumulator 1a is finally limited by a fourth housing element 8a, in this case a cover element. The cover element 8a comprises hooks 9 engaging in recesses of the side elements 6a and 6b. Additionally, snap hooks 10 (for example, shown in FIG. 3) are located at the bottom side of the side elements 6a and 6b, by means of which the accumulator 1a can be assembled without any tools. Yet the projections 5, the hooks 9 and the snap hooks 10 result in a stable connection of the components of the accumulator 1a. In an advantageous embodiment, the cover element 8a additionally comprises a cell connection unit, by means of which the cells 2 can be electrically interconnected. For example, the cells 2 may be connected in parallel, in series or in a mixed manner.

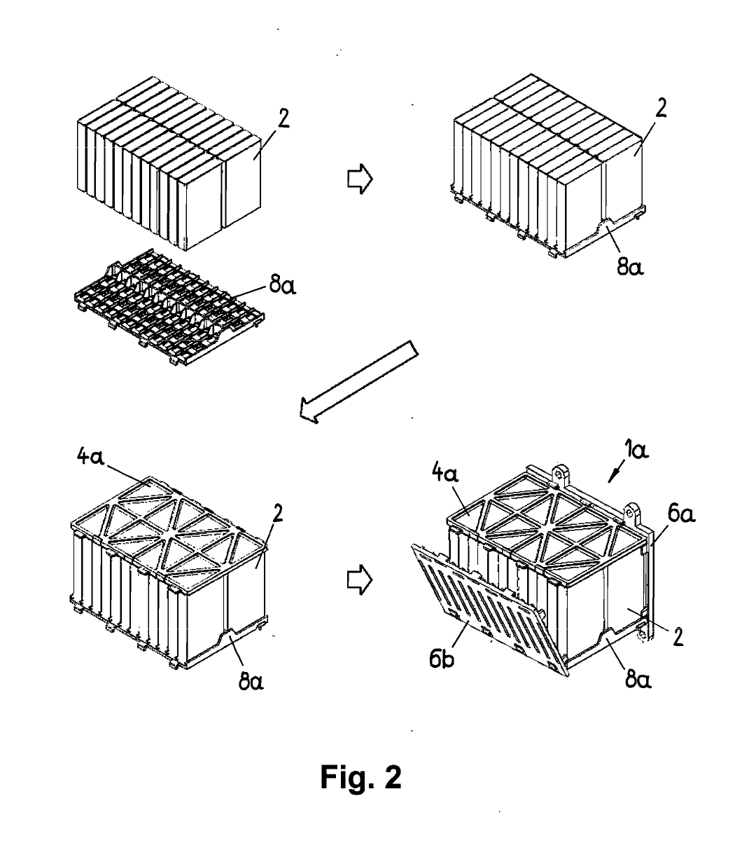

FIG. 2 shows the sequence during assembly of the accumulator 1a beginning with the top left representation. In a first step, the cells 2 are placed head first onto the cover element 8a. In order to fit in the cells 2 without play, the cover element 8a comprises elevations 12 on webs 11 separating the cells 2 from one another (shown in FIG. 4). The top right picture shows the state after the cells 2 have been placed onto the cover element 8a. In a third step, which is shown in the bottom left representation, the bottom element 4a is placed onto the cells 2. In a fourth step, which is shown in the bottom right representation, finally the side parts 6a and 6b are hooked into the hooks 9 of the cover element 8a and then folded laterally onto the bottom element 4a. Therein on the one hand the projections 5 engage in the recesses of the side parts 6a and 6b, on the other hand the snap hooks 10 lock in place at undercuts of the bottom element 4a, so that a stable connection of the components is realized.

Advantageously, the bottom element 4a and the cover element 8a in this example are point symmetric, i.e. the two elements 4a and 8a may also be mounted at a position rotated by 180°, which facilitates assembly of the accumulator 1a. However, this is not an absolutely necessary requirement. The mentioned elements 4a and 8a may also be asymmetric. Likewise it would be conceivable that the side elements 6a and 6b are designed to be point symmetric in order to further facilitate assembly of the accumulator 1a.

FIG. 3 shows a cross section of the accumulator 1a in order to make clear how the components interlock. It can be seen especially well how the projections 5 and the hooks 9 engage in recesses in the side part 6b (in analogous manner in the side part 6a). Further, it can also be seen well how the snap hooks 10 lock in place at the undercut of the bottom element 4a. When the side elements 6a and 6b are folded thereon, the snap hooks 10 are pressed downwards due to the ramp-shaped configuration of the bottom element 4a in this region and spring back upwardly at the end of said ramp, whereby the side parts 6a and 6b are connected to the bottom element 4a in a stable manner.

FIG. 4 shows a portion of the cover element 8a in a bottom-up representation. The representation well shows the individual shell-shaped indentations, which are prepared for receiving one cell 2 each and which are formed by webs 11. Advantageously, elevations 12 are arranged on the webs 11, providing secure support of the cells 2 as well as tolerance compensation.

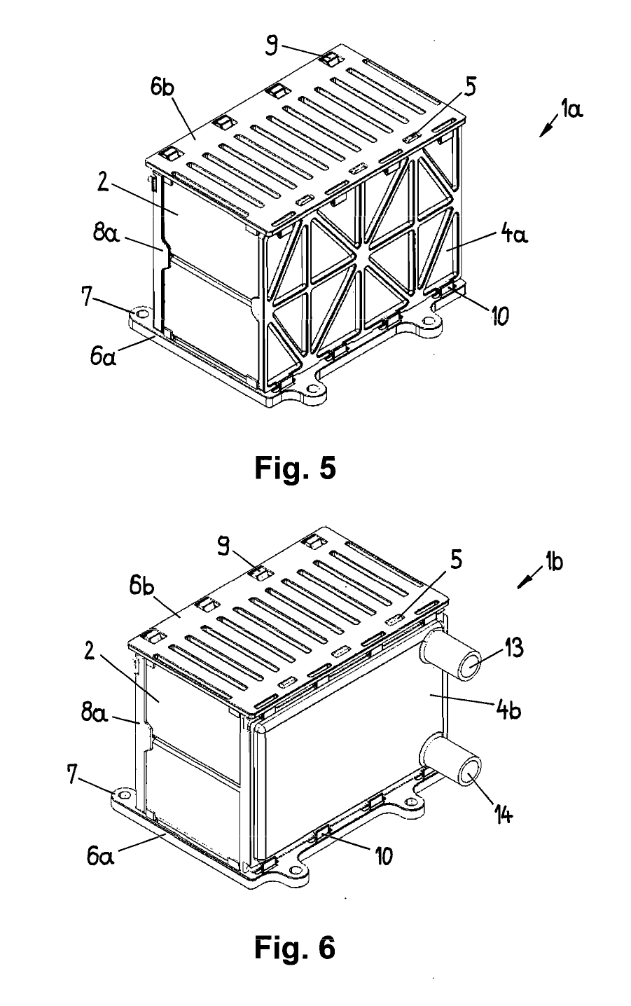

FIG. 5 shows the finished accumulator 1a as seen angularly from below. Therein the bottom element 4a is well to be seen. In FIG. 6 the bottom element 4a is replaced by an alternative housing element 4b, namely by an alternative bottom element. The alternative housing element 4b comprises the same connection means, namely projections 5 as well as an undercut for the snap hook 10, as the housing element 4a such that the alternative housing element 4b can be used directly instead of the housing element 4a. This means that in addition to exchanging the housing element 4a for the alternative housing element 4b no further retrofitting work at the accumulator 1b is necessary.

In this way a modular system can be realized for an essentially cuboid-shaped accumulator 1a, 1b, wherein an alternative housing element 4b can be used instead of a housing element 4a fulfilling a first function and fulfills a second function different from the first function.

Concretely, the alternative housing element 4b consists of a material having an integrated channel which is prepared for being flown through by a fluid. Said channel (or else several channels) is connected to an inlet 13 and a discharge 14, by the aid of which the bottom element 4b can be connected to a cooling system and can be temperature-adjusted (cooled or heated) by means of fluid (liquid or gaseous). In this way the cells 2 can be brought to an optimal operating temperature. Therein the channel inside the bottom element 4b may be laid in any shape, for example, in a meandering shape, and may have any cross section, for example, a rectangular or a circular one.

In contrast, the bottom element 4a consists of a massive material or of a material having closed cavities (a foamed material). The bottom element 4a therefore fulfills a function completely different from that of the alternative bottom element 4b.

Further it can be seen from FIGS. 1 to 6 that the two side parts 6a and 6b comprise identical attachment means, namely recesses for the projections 5 and the hooks 9 as well as snap hooks 10, but that they fulfill different functions. Concretely, the side element 6a comprises attachment means 7 (in this case for attaching a side element in parallel to a base surface), whereas the side element 6b does not have any attachment means (i.e. the side element 6b can be arranged in any way relatively to a base surface). Thus the side element 6a can be understood as an alternative side element for the side element 6b and vice versa. For example, an accumulator may also comprise two side elements 6b. In this case the two housing elements 6b are identical.

In addition to the side elements 6a and 6b shown the modular system may have still further side elements. For example, they may comprise mounting means for attaching a side element in perpendicular to a base surface or else mounting means for attaching a side element angularly to a base surface.

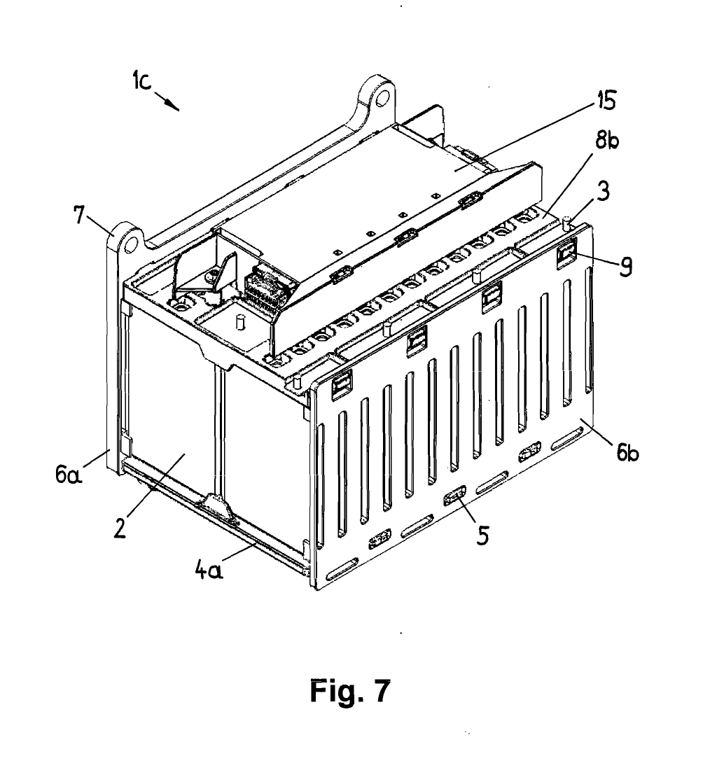

FIG. 7 shows another variant of the invention in the form of an accumulator 1c, which is very similar to the accumulator 1a shown in FIG. 1. In contrast thereto, however, the accumulator 1c comprises a cover element 8b having an alternative cell connection unit as well as a cell monitoring unit 15 for electronic monitoring of the voltage generating cells 2. In this way, several different cover elements 8a and 8b are created which have identical attachment means to the side parts 6a and 6b, in this example concretely the hooks 9, but fulfill different functions. For example, the different cover elements 8a and 8b of a modular system may, as already mentioned, effect a series connection of the cells 2, a parallel connection of the cells 2 or a combined series and parallel connection. The cells 2 can now be interconnected in a simple manner by selecting a corresponding cover element 8a, in order to achieve a desired voltage or a desired capacity of the accumulator 1c.

As shown above, the modular system thus comprises for the essentially cuboid-shaped accumulator 1a . . . 1c several loose housing elements 4a, 4b, 6a, 6b, 8a, 8b, which can be combined as needed. As the terms “housing element” and “alternative housing element” designate two housing elements which may be used alternatively at the same position of the housing, the mentioned terms can also be used as exchangeable terms.

In the examples shown, a housing element 4a, 4b, 6a, 6b, 8a, 8b are always formed by exactly one side part, i.e. each housing element 4a, 4b, 6a, 6b, 8a, 8b always limits one respective side of the cuboid-shaped accumulator 1a . . . 1c. Further, in the examples shown, the accumulator 1a . . . 1c at its assembled state is limited by the housing elements 4a, 4b, 6a, 6b, 8a, 8b at exactly four sides. Though advantageous embodiments of the invention are formed thereby, the mentioned conditions are not absolutely necessary. Of course, one of the two end sides or both end sides of the accumulators 1a . . . 1c may be limited by a housing element, too. Furthermore a housing element 4a, 4b, 6a, 6b, 8a, 8b may also be formed by several side parts connected through a hinge or of several side parts connected angularly and fixedly with respect to one another. For example, the cover element 8a and the two side elements 6a and 6b may be interconnected through hinges. The mentioned parts may also be connected fixedly to one another and form a U-shaped housing element. In this way, the number of work steps required for assembling the accumulator 1a . . . 1c can be reduced.

In another advantageous variant of the invention, at least two of the components of the accumulator 1a . . . 1c, in particular several voltage generating cells 2, are glued together. Of course, it is also possible to glue the housing elements 4a, 4b, 6a, 6b, 8a, 8b to one another or to the cells 2.

Therein an especially advantageous method of manufacturing an accumulator 1a . . . 1c according to the invention comprises the steps:
a) applying adhesive to at least one of the components 2 . . . 15 of the accumulator 1a . . . 1c;
b) assembling said components 2 . . . 15;
c) fixing the components 2 . . . 15 by actuating the snap hooks 10; and
d) storing the accumulator 1a . . . 1c in a free-standing manner until the adhesive has hardened.

In this way the accumulator 1a . . . 1c can on the one hand be manufactured without any tools, on the other hand a durable connection is achieved by gluing together the parts concerned. For the hardening of the adhesive, the accumulator 1a . . . 1c is advantageously stored in a free-standing manner, i.e. there is no need for a clamping device for pressing the parts to be glued to one another together. Though generally the use of snap hooks 10 is advantageous, it is not absolutely necessary for the modular system according to the invention. For example, the parts may also be screwed, riveted or connected in another way. Further, the snap hooks 10 may differ from the shape shown herein and be configured corresponding to other clip connections which are known per se. For example, essentially cylindrical pins may be used, which lock in place when inserted in a hole.

The accumulator 1a . . . 1c is especially suitable for being used in motor vehicles. Therein it is in particular advantageous that the accumulator 1a . . . 1c can be very easily adapted to the various requirements of different vehicles due to the measures according to the invention. Of course, the accumulator 1a . . . 1c can also be used beyond the field of motor vehicle engineering.

Finally, it is stated that, as the case may be, representations of parts in the figures are not true to scale and that the individual variants represented in the figures may also form the subject-matter of an independent invention. Positional information, such as “right”, “left”, “top”, “bottom” and the like refer to the represented position of the respective component and are to be correspondingly adapted within the spirit of the invention if the stated position changes.

1-15. (canceled)

16. A modular system for an essentially cuboid-shaped accumulator (1a . . . 1c), comprising the following components:
at least one voltage generating cell (2) and
at least two loose housing elements (4a, 4b, 6a, 6b, 8a, 8b) each comprising maximally three side parts and together comprising at least four side parts, wherein each side part is provided for limiting one respective side of the cuboid-shaped accumulator (1a . . . 1c), wherein
at least one additional alternative housing element (4a, 4b, 6a, 6b, 8a, 8b) which can be directly used instead of a housing element (4a, 4b, 6a, 6b, 8a, 8b) fulfilling a first function and which fulfills a second function different from the first function.

17. The modular system according to claim 16, wherein, by the housing element (4a, 4b, 6a, 6b, 8a, 8b) and the at least one alternative housing element (4a, 4b, 6a, 6b, 8a, 8b), at least two functions or embodiments of the following group are realized: consisting of a massive material, consisting of a material having closed cavities or consisting of a material having an integrated channel which is prepared for being flown through by a fluid.

18. The modular system according to claim 16, wherein the housing element (4a, 4b, 6a, 6b, 8a, 8b) and the at least one alternative housing element (4a, 4b, 6a, 6b, 8a, 8b) each comprise a cell connection unit for electrical connection of at least two voltage generating cells (2); and
wherein, by the housing element (4a, 4b, 6a, 6b, 8a, 8b) and the at least one alternative housing element (4a, 4b, 6a, 6b, 8a, 8b), at least two functions or embodiments of the following group are realized: forming a series connection of the cells (2), forming a parallel connection of the cells (2), forming a first combined series and parallel connection of the cells (2) or forming a second combined series and parallel connection of the cells (2) which is different from the first combined series and parallel connection.

19. The modular system according to claim 16, wherein, by the housing element (4a, 4b, 6a, 6b, 8a, 8b) and the at least one alternative housing element (4a, 4b, 6a, 6b, 8a, 8b), at least two functions or embodiments of the following group are realized: comprising mounting means (7) for attaching a side element in parallel to a base surface, comprising mounting means for attaching a side element in perpendicular to a base surface, comprising mounting means for attaching a side element angularly to a base surface or provided for any desired arrangement relatively to a base surface.

20. The modular system according to claim 16, wherein a housing element (4a, 4b, 6a, 6b, 8a, 8b) comprises a cell monitoring unit (15) for monitoring at least two voltage generating cells (2).

21. The modular system according to claim 16, wherein a housing element (4a, 4b, 6a, 6b, 8a, 8b) is formed of exactly one side part.

22. The modular system according to claim 16, wherein a housing element (4a, 4b, 6a, 6b, 8a, 8b) is formed by at least two side parts connected through a hinge.

23. The modular system according to claim 16, wherein a housing element (4a, 4b, 6a, 6b, 8a, 8b) is formed by at least two side parts connected angularly and fixedly with respect to one another.

24. The modular system according to claim 16, wherein the at least two housing elements (4a, 4b, 6a, 6b, 8a, 8b) can be connected to one another through snap hooks (10).

25. The modular system according to claim 16, wherein the housing elements (4a, 4b, 6a, 6b, 8a, 8b) are prepared for limiting the accumulator (1a . . . 1c) at its assembled state at exactly four sides.

26. The modular system according to claim 16, wherein at least two housing elements (4a, 4b, 6a, 6b, 8a, 8b) are identical.

27. The modular system according to claim 16, wherein a housing element (4a, 4b, 6a, 6b, 8a, 8b) is point symmetric.

28. An accumulator (1a . . . 1c) comprising the components of the modular system according to claim 16.

29. The accumulator (1a . . . 1c) according to claim 28, wherein at least two of the components (2 . . . 15) are glued together.

30. A method of manufacturing an accumulator (1a . . . 1c) according to claim 24, comprising the steps:
a) applying adhesive to at least one of the components (2 . . . 15) of the accumulator (1a . . . 1c);
b) assembling said components (2 . . . 15);
c) fixing the components (2 . . . 15) by actuating the snap hooks (10); and
d) storing the accumulator (1a . . . 1c) in a free-standing manner until the adhesive has hardened.
